(19) United States
(12) Patent Application Publication
(10) Pub. No.: US 2005/0013749 A1
(43) Pub. Date: Jan. 20, 2005

(54) One piece catalytic converter housing with integral end cone

(76) Inventors: Clinton J. McAllister, Woodstock (CA); Martin W. Kalish, Sterling Hts., MI (US)

Correspondence Address: HARNESS, DICKEY & PIERCE, P.L.C., P.O. BOX 828, BLOOMFIELD HILLS, MI, 48303, US

(21) Appl. No.: 10/812,009

(22) Filed: Mar. 26, 2004

Related U.S. Application Data
(60) Provisional application No. 60/458,178, filed on Mar. 27, 2003.

(51) Int. Cl. B01D 53/34

(52) U.S. Cl. 422/179; 422/177; 422/180; 29/890

(57) ABSTRACT

The present invention relates to catalytic converter assemblies and, more particularly to a one piece catalytic converter housing with an integral end cone which is welded to a second end cone to provide a substantially air tight seal to the assembly.

### CROSS-REFERENCE TO RELATED APPLICATIONS

This application claims the benefit of U.S. Provisional Application No. 60/458,178 filed on Mar. 27, 2003.

### DISCUSSION OF PRIOR ART

The present invention relates to catalytic converter assemblies and, more particularly to a one piece catalytic converter housing with an integral end cone. Catalytic converter assemblies are typically formed by mechanically fastening stamped or otherwise machined inlet cones, outlet cones and converter housings together to contain the conversion materials. Among the perceived drawbacks to this type of catalytic converter assembly are the costs associated with assembling multiple pieces to arrive at a useful component and the inherent gas leak paths associated with mechanical fasteners.

### SUMMARY OF THE INVENTION

In a first instance, the present invention addresses the above described drawbacks, among others, by providing a catalytic converter assembly employing a one-piece catalytic converter housing and integral end cone to limit the number of overall components in the assembly.

In addition to catalytic converter assemblies including a one piece catalytic converter housing with integral end cone, the present invention also relates to a method of manufacturing catalytic converter assemblies by welding a second end cone or second end portion of an exhaust manifold to the one piece catalytic converter housing and integral end cone. This second end cone may be a stand alone component or alternatively may itself be integrally formed as a portion of an exhaust manifold as shown in FIG. 1.

### DESCRIPTION OF THE DRAWINGS

FIG. 1 is a cross-sectional view of a first catalytic converter assembly embodiment according to the teachings of the present invention;

FIG. 2 is a cross-sectional view of a second catalytic converter assembly according to the teachings of the present invention; and

FIG. 2A is a magnified view taken from FIG. 2 demonstrating the weld joint of the catalytic converter assembly.

### DETAILED DESCRIPTION OF THE INVENTION

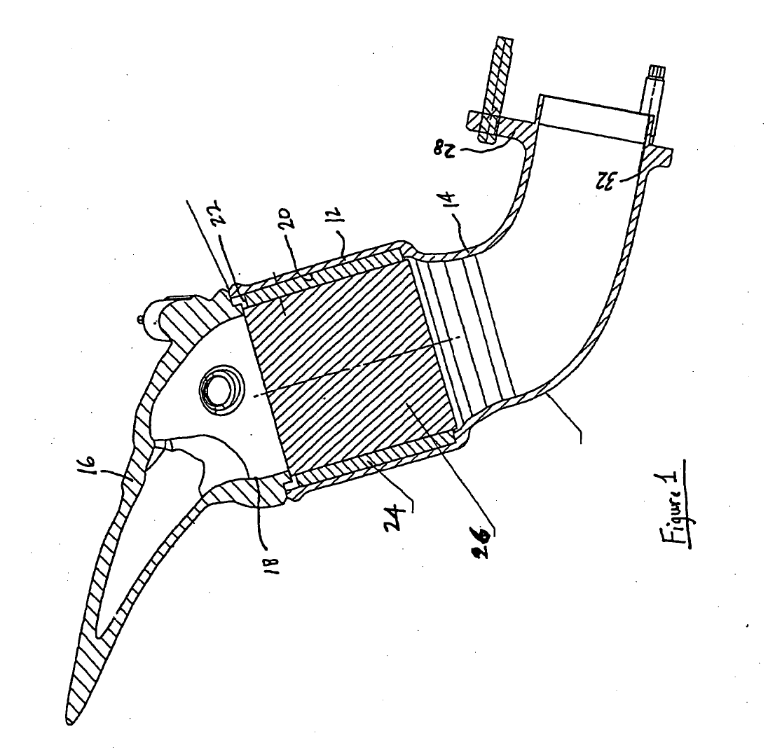

Referring to FIG. 1, there is shown a one piece catalytic converter housing and integral end cone assembly 10. The converter housing portion is defined by reference numeral 12 and the end cone portion, otherwise referred to herein as the “outlet cone” is defined by reference numeral 14. The catalytic converter housing and integral end cone are preferably formed as a casting. While numerous materials may be suitable for casting the one piece catalytic converter and end cone, cast irons and, preferably SiMo cast irons are preferred. Generally, the catalytic converter housing portion 12 includes an opening 22 defined by an inner wall 20 for receiving the catalytic converter components necessary for converting the exhaust gases prior to discharge from the vehicle to the atmosphere. As depicted, the integral end cone portion, 14A, may include a radially extending muffler mounting flange 28 located along the free end 32 of the integral end cone. These converter components generally include a filtering substrate 24 and a mounting mat 26 which assists in maintaining the substrate within the converter housing.

The mounting mat 26 is generally formed from a high temperature material that is compressible with spring like properties that is compressed between the inner wall of the converter housing and ceramic substrate outer wall. Mat material takes up variations and tolerances in the physical dimensions of both mating parts and in their thermal expansions. The mat also serves to hold the substrate in place with its pressure (spring force) and surface friction and provides a gas seal between the substrate container wall. Ideally, the material of the mat will have engineered expansion characteristics vs. temperature to enhance its ability to take up the varying thermal expansion between the substrate and container wall.

The filtering substrate 24 may be selected from various material but generally includes a multiple channel for example, (400 to 900 cells/channels per square inch) high surface area high temperature ceramic (cordierite) material suitable for coating with a catalytic material.

According to the embodiment depicted in FIG. 1, a second end cone portion 18 is integrally formed with the exhaust manifold 16 as a one piece cast component. The exhaust manifold 16 and one piece catalytic converter and end cone assembly 10, when appropriately joined form the “hot end” portion of an exhaust system.

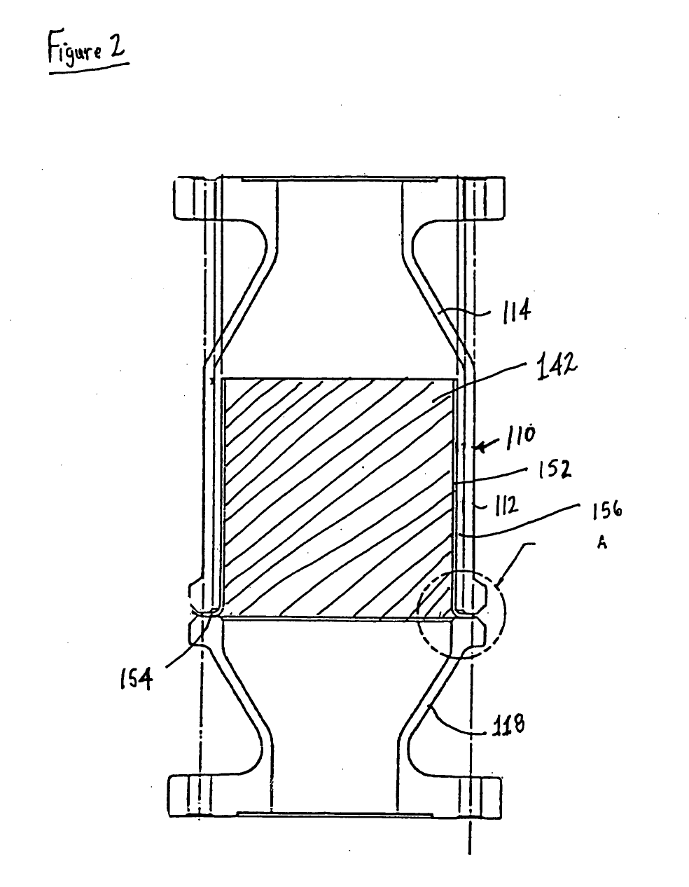

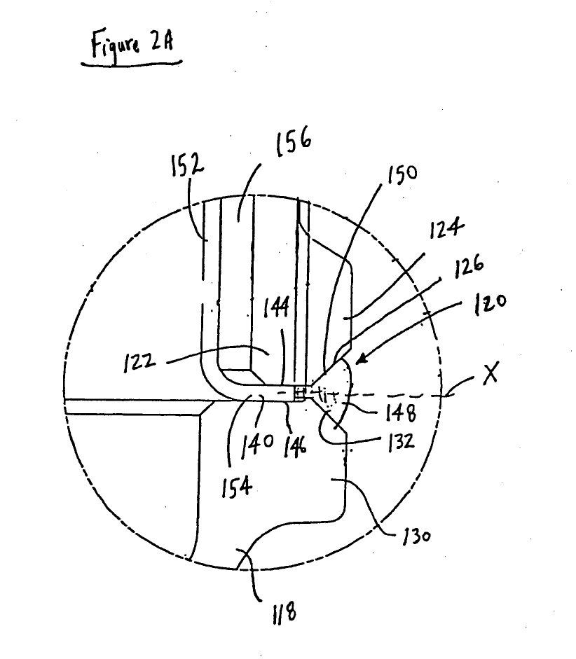

Referring to FIG. 2, an alternative embodiment of a hot end portion of an exhaust system is illustrated exclusive of the exhaust manifold, if employed. As with the embodiment of FIG. 1, a key component of this assembly is the use of a one piece catalytic converter housing and end cone assembly 110. While the embodiment as shown is more of an in-line design, it too includes both a catalytic converter housing portion 112 of an outlet end cone portion 114 formed as a single piece. The embodiment of FIG. 2 also contemplates a second end cone portion 118 which is mated to the assembly 110 employing a unique weld joint 120 which will now be described.

While the weld joint of the present invention is applicable to the embodiments of FIG. 1 and FIG. 2, respectively, for convenience, the weld joint, will be described with particular reference to FIGS. 2 and 2A. To achieve a dynamic weld along the weld joint, a first end 122 of the one piece assembly 110 includes an annular flange 124 having an inwardly angled downwardly tapering portion 126. The other portion of the weld joint 120 is contributed by a complimentary annular flange 130 provided along a mating edge of the second end cone portion 118 which includes an inwardly angled tapering portion 132. Preferably the angled portions 126 and 132 along the weld joint will be at an approximate 45° angle from a center line X, thereby forming an annular recess for the weld material for providing an air tight seal between said connector housing and the second end cone.

As illustrated under the embodiment presented in FIG. 2 and 2A, an advantage of utilizing this type of weld joint relates to the ability to capture the mantle 140 between the end wall 144 of the catalytic converter and the end wall 146 of the second end cone utilizing a single annular weld 148 along the weld joint.

The material 140 is generally formed from stainless steel including a hollow body portion 152 for receiving the substrate 142 and lip 154 extending outwardly from the body 152. The substrate 142 according to this embodiment, may be made from high temperature corrugated steel foil wrapped so that it has multiple axial channels (300 to 900 cells/channels per square inch typical) and high surface area, brazed to the inner surface of the tubular stainless steel support mantle. The substrate surface is used as a carrier of the catalytic material.

In view of the fact that the converter substrate 142 and particularly the mantle portion 140 of the converter substrate may be formed of a material other than that which is utilized to cast the one piece assembly 110, care should be taken in selecting the appropriate weld wire material to insure that a robust weld occurs along the joint. By way of non-limiting example, if the mantle of the converter substrate is formed from a stainless steel material such as type 409 stainless steel, and both the one piece assembly and the second end cone are formed from a SiMo cast iron composition, a suitable weld wire material is believed to be Inco FM 44 HT. Examples of useful SiMo cast iron compositions are set forth in U.S. Pat. No. 6,508,981 which is hereby incorporated by reference.

Among the numerous advantages of the one piece catalytic converter housing with integral end cone is the elimination of at least one joint which in turn limits the number of potential leak paths along the assembly. As the number of assembly joints increase, the cost to assemble also tends to increase. Thus, it is believed that the embodiments presented herein represent a potential cost savings to the manufacturer.

1. A catalytic converter assembly comprising;
catalytic conversion components;
a one piece catalytic converter housing with integral end cone, said converter housing including an opening for receiving the conversion components; and
a second end cone which is welded to said catalytic converter housing such that a weld joint is formed between said housing and said second end cone.

2. The catalytic converter assembly of claim 1, wherein said catalytic converter housing with integral end cone is formed by casting.

3. The catalytic converter assembly of claim 2, wherein said catalytic converter housing with integral end cone casting is formed from SiMo iron.

4. The catalytic converter assembly of claim 1, wherein said integral end cone includes a muffler mounting flange.

5. The catalytic converter assembly of claim 1, wherein said muffler mounting flange is located along a free end of said integral end cone.

6. The catalytic converter assembly of claim 1, wherein said weld joint provides a substantially air tight seal between said catalytic converter housing and a said second end cone.

7. The catalytic converter assembly of claim 1, wherein said second end cone integrally extends from an exhaust manifold, wherein said second end cone and said second exhaust manifold are cast as a single piece.

8. The catalytic converter assembly of claim 1, wherein said catalytic converter housing includes an annular flange having an inwardly angled portion and said second end cone includes a complimentary annular flange having an inwardly angled portion, whereby upon joining said second end cone to said converter housing an annular recess is provided to define said weld joint.

9. The catalytic converter assembly of claim 1, wherein said catalytic converter further comprises a mounting mat disposed adjacent an inner wall defining said opening and a filtering substrate disposed within said mounting mat.

10. The catalytic converter assembly of claim 1, further comprising a mantle disposed within said catalytic converter housing for receiving a filtering substrate.

11. The catalytic converter assembly of claim 10, wherein said mantle includes an outwardly extending lip which is sandwiched between said catalytic converter housing and said second end cone.

12. The catalytic converter assembly of claim 11, wherein said weld joint occurs along a junction defined by said catalytic converter housing, and said second end cone and said mantle.

13. The catalytic converter assembly of claim 12, wherein said catalytic converter housing includes an annular flange having an inwardly angled portion and said second end cone includes a complimentary annular flange having an inwardly angled portion, whereby upon joining said second end cone to said converter housing an annular recess is provided to define said weld joint.

14. A method of manufacturing a catalytic converter assembly comprising the steps of:
a) providing catalytic conversion components;
b) providing a one piece catalytic converter housing and integral end cone, said housing including an opening for receiving said catalytic conversion components;
c) disposing the catalytic converter components within the opening of said catalytic converter housing;
d) attaching a second end cone portion to said catalytic converter housing to capture the catalytic converter within said catalytic converter assembly; and
e) welding the second end cone to said one piece catalytic converter housing and integral end cone to form the catalytic converter assembly.

15. The method according to claim 14, wherein a mantle for receiving a filtering substrate is disposed within said catalytic converter housing opening said mantle including an outwardly extending lip disposed between said housing and said second end cone prior to welding the second end cone to the one piece catalytic converter housing.

16. The method according to claim 14, wherein said second end cone integrally extends from an exhaust manifold, wherein said second end cone and said exhaust manifold are cast as a single piece.
